(19) United States
(12) Patent Application Publication
(10) Pub. No.: US 2010/0116703 A1
(43) Pub. Date: May 13, 2010

(54) PROTECTIVE CASE AND METHOD OF ITS MANUFACTURE

(76) Inventor: Luis Elenes, Portland, OR (US)

Correspondence Address: Mohr Intellectual Property Law Solutions, P.C., 16814 NW Oak Creek Dr., Beaverton, OR, 97006, US

(21) Appl. No.: 12/614,306

(22) Filed: Nov. 6, 2009

Related U.S. Application Data
(60) Provisional application No. 61/112,631, filed on Nov. 7, 2008.

(51) Int. Cl. B65D 85/38; B31B 1/14; B65D 85/00

(52) U.S. Cl. 206/316.2; 493/56; 206/320

(57) ABSTRACT

A protective case, typically configured to hold an electronic device within its enclosed central space, is disclosed. The case includes a body having roughly rectangular sides and a hinged lid. The lid may be held to the body by magnetic attraction when the lid is down. The lid may include a backup security mechanism in the form of a resilient shock cord that can be coupled to (or tether) the lid and the body. The case may also include a hanger configured to rotate between raised and lowered positions, where the hanger also includes a magnet configured to hold the hanger against the body when the hanger is in at least one of its raised and lowered positions.

### CROSS-REFERENCE TO RELATED APPLICATION

This application claims priority from U.S. Provisional Patent Application No. 61/112,631 filed Nov. 7, 2008, and from U.S. Design patent application Ser. No. 29/314,793 filed Apr. 29, 2009. The disclosures of the cited related applications are incorporated herein by reference in their entirety for all purposes.

### BACKGROUND

There is little purpose in taking a camera or other electronic device on a trip involving rock or mountain climbing or other strenuous outdoor activity is pointless if it will be too much of a hassle to take the camera or electronic device out of its case during a vertical climb, pitch, or other exposed situation. Most modern cameras are very small and can produce excellent images, while many music or video devices provide great entertainment in a small form factor. It is desirable to carry such electronics in a way that it is accessible, such as with a single hand, yet protected from the elements when not in use. The “elements” can include waist deep snow, substantial down-climbing, body-sized, off-width granite cracks, mountain biking, and running, to name a few. As one example, climbers carry, use, and manipulate gear constantly during the course of a climb. This gear should be accessible, dummy-proof, lightweight and durable: the less accessible a piece of gear, the more likely it will not get used, and gear that it is not used in the course of a pitch, route, or climb can be a liability to the pursuit.

Cases commonly used for holding and protecting relatively small electronic devices are often constructed of relatively flexible materials and often require that they be fastened to a belt or other portion of the attire of a person. A typical camera or electronics case may include a number of articulating segments and components, and one of any number of releasable systems to ensure closing of the case. Many cases may be easy to use but, at the same time, not provide optimal protection to an enclosed electronic device. Conversely, highly protective cases may be somewhat difficult to utilize Further, typical electronics cases that provide substantial protection to the enclosed device require that the user attend to the opening and closing mechanisms with both hands, which occupies the user's hands and prevents the user from performing other operations or, in the case of outdoor activities, from ensuring his or her own safety.

With the current size and weight of modern point and shoot cameras, electronic listening devices, and other electronics, it is possible, and desirable, to be able to access those devices quickly, easily, and safely. However, typical rigid electronics cases that provide high levels of protection and durability tend to be large, fairly heavy, and clumsy to use. An exemplary desirable case for carrying a point-and- shoot camera, among other electronic devices, in an exposed situation would provide all the protection of a traditional hard case, while having less size and weight and while allowing ready access for the use and storage of the camera, desirably with a single hand.

In one aspect of an illustrated embodiment of such a protective case, the case can be just large enough to accommodate a small point and shoot camera with no space wasted for water seals and excessive padding that is not relevant in many outdoor activities. In another aspect of an illustrated embodiment, the case does not open by splitting down the middle, thus decreasing significantly the risk of dropping the camera or other stored electronic device. It is expected that, apart from mountain climbers, the illustrated protective case can find use with users such as hikers, boaters, hunters, bikers, military and police (to name a few).

Related disclosures of cases for holding cameras or other relatively small electronic devices are found in Publications U.S. Pat. No. 3,813,017, U.S. Pat. No. 4,479,596, U.S. Pat. No. 4,834,274, U.S. Pat. No. 4,896,805, U.S. Pat. No. 6,138,826, U.S. Pat. No. 6,244,486, U.S. Pat No. 6,377,755, U.S. 6,929,125, U.S. Pat. No. 6,953,126, U.S. Pat. No. 7,032,792, US2005/0167304, US2007/0193901, and US2008/0156833. The disclosures of all the patents and patent application publications recited in this and other paragraphs are incorporated herein by reference in their entirety for all purposes.

### SUMMARY

The present disclosure provides an embodiment of a camera case especially useful during rock climbing, alpine climbing, mountaineering, skiing, and other outdoor oriented pursuits. Desirable characteristics of the disclosed case embodiment are its low weight, compactness, durability, aesthetically unique appearance, and high-quality construction. The basic design and related components of embodiments of the case allow a camera or other electronic device to be carried easily on a user's climbing harness, backpack strap, or other accessory carrier and to be freely accessible to manipulation with a single free hand. The design of the case embodiment and its method of use allow the camera to be accessed with a significantly reduced chance of it being dropped upon removal from and replacement into the camera case. In addition, the method of manufacture of the disclosed embodiment allows the case to have a high strength to weight ratio.

The principles disclosed for the described camera case can also be used in cases made to protect any number of other types of electronic devices. As well, though noted as useful in climbing-type activities, the described camera case may be useful under any conditions where the performed activity places a carried camera or electronic device at high risk of being damaged. A novel feature of the disclosed camera case includes its ability to be operated simply with one hand of a user, in a manner that allows secure protection of an electronic device and ease of its withdrawal from the case.

### BRIEF DESCRIPTION OF THE DRAWINGS

FIG. 1 is a perspective view of an embodiment of a case for electronic devices according to the present disclosure.

FIG. 2 is a side view of the embodiment of FIG. 1.

FIG. 3 is a rear view of the embodiment of FIG. 1.

FIG. 4 is a first front view of the embodiment of FIG. 1.

FIG. 5 is a second front view of the embodiment of FIG. 1.

FIG. 6 is a component suitable for constructing a portion of the embodiment of FIG. 1.

FIG. 7 is another component suitable for constructing a portion of the embodiment of FIG. 1.

FIG. 8 is another component suitable for constructing a portion of the embodiment of FIG. 1.

### DETAILED DESCRIPTION

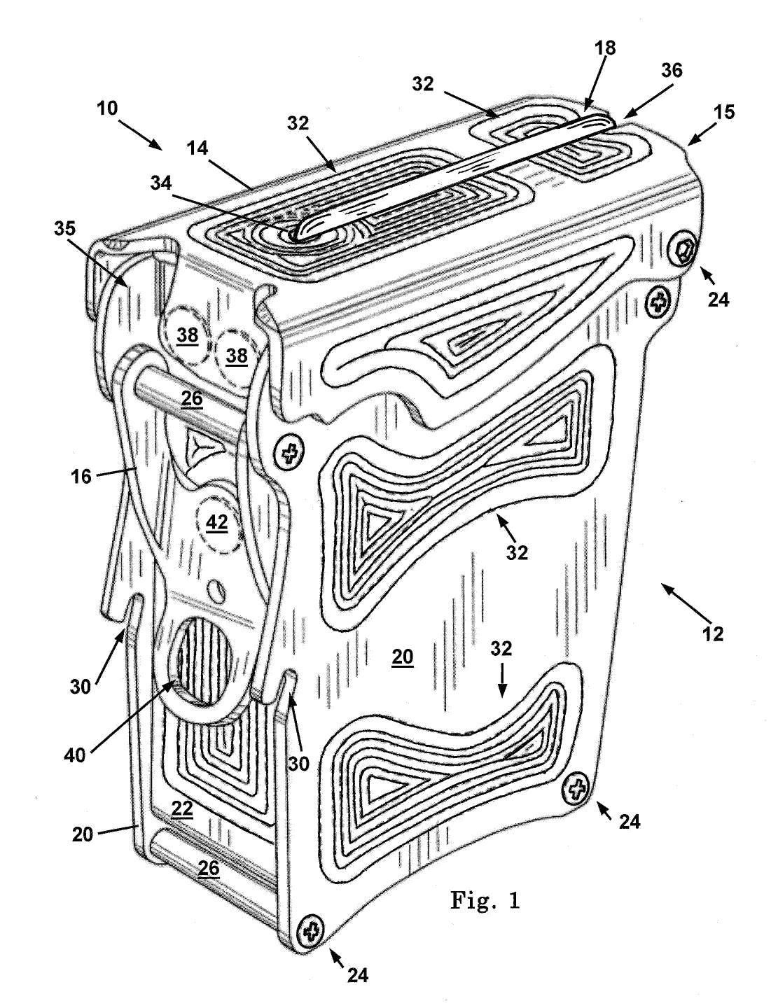

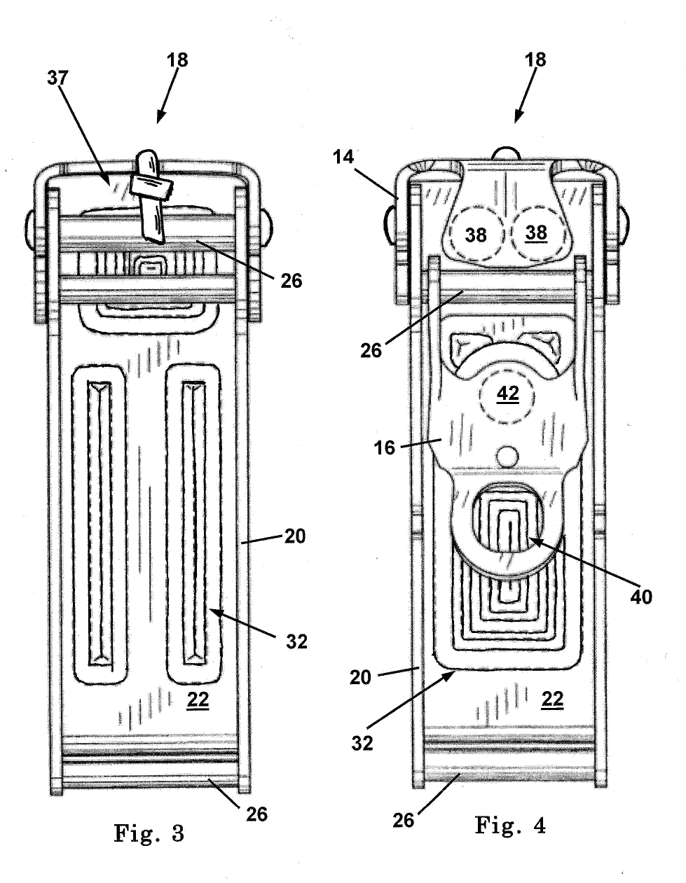

FIGS. 1-5 show perspective, side, rear, and two front views, respectively, of a case 10 for carrying electronic devices, for example a handheld compact camera. The illustrated embodiment of a case 10 includes a body 12, having a roughly rectangular cross-section, that is coupled to a lid 14, and which includes a hanger 16. The lid 14 may be hinged to the body 12 at one of the lid's ends 15, and the lid may house a securement mechanism 18 that may be at least temporarily anchored to a portion of the lid. In the illustrated embodiment, the securement mechanism is a length of shock cord that can reversibly hold portions of the case in a fixed relationship.

Typically, body 12 of case 10 may include at least a pair of side walls 20 that are fastened to a central shell 22 by a plurality of bolts or screws 24. To hold the side walls with the appropriate separation to accommodate the central shell, the bolts or screws may interface with a number of spacer bars 26 placed at the appropriate locations on the case body. In this case, the spacer bars and bolts or screws may be provided with complementary threading to accommodate reversible attachment of the bars and body components. Though not shown in the Figures, the interior surfaces of the side walls, central shell, and/or lid may be lined with a foam or other padding material configured to absorb shock and or moisture to protect a carried electronic device, as known to those of skill in the art. This material, though not causing the case to be waterproof, may be used to make the case water resistant, in conjunction with the design of the lid and other body components.

Some embodiments of a case 10 may further include one or more rails 28 securely mounted on one or more of the side walls; these rails may serve as attachment points to which external support structures may be fixed, or through which the supports may be threaded (for example, if the external support is a length of webbing or rope). Typically, each end of a rail is mounted to a screw 24, such that a space is created between the underside of the rail and the side wall 20. A strap or other attachment mechanism could then be threaded through this space to secure the case to the strap.

Portions of one or more of the side walls 20 may include a notch 30 into which one end of the securement mechanism 18 may be placed for securing the lid to the body of the case. As well, portions of one or more of the side walls 20 may contain shaped features 32, which may increase the ability of the case to be grasped by a bare or gloved hand. These shaped features may have a “scalloped,” or stepped, profile, where the outer rim of the feature is even with the surface of the side wall, and the central region of the feature is located in a depression in the wall, stepped down from the rim. Though many designs for this scalloped feature are possible, in the illustrated embodiment the steps move downward in approximately one-sixteenth-inch increments. Typically, when the case is constructed of metallic material, the scalloped features may be formed by CNC machining.

As noted, the case 10 may include a securement mechanism 18, which may be embodied in the form of a length of shock cord. In a typical embodiment, the length of shock cord will be anchored at one of its ends to an anchor hole 34 in the lid 14. At the other of its ends, the shock cord may be anchored to a lid notch 36. In a simple, yet effective, design, the shock cord may include a knot 37 at each of its ends, placed such that one knot is at an undersurface of the lid (when the lid is closed) and the other knot is outside the case. In other words, the shock cord (or other appropriate securement mechanism) spans the anchor hole with its central length, having a knot (or other fixation element) disposed toward each of the inner and outer sides of the hole. In other embodiments, the cord may not include a knot at each end, but may include an attachment (such as a clip, or fastener) that can also serve to prevent the cord from being pulled freely through the anchor hole 34, lid notch 36, or notch 30.

Typically, the relaxed length between the fixation portions (or knots 37) of a shock cord securement, or other appropriate securement device, will be just less than the distance between the anchor hole 34 and the securement notch 36 or notches 30. In this way, stretching the shock cord, or other appropriate securement device, beyond its resting length will cause it to continually apply a pulling force against its knots. This will allow shock cord to reside stably along a top portion of the lid (where the knots are hooked into, and pulled against, anchor hole 34 and notch 36), or to assist in keeping the lid closed (where the knots are hooked into, and pulled against, anchor hole 34 and one or both of notches 30).

As noted above, the lid 14 typically has a hinged relationship with the body 12 of the electronics case, as where the lid rotates around an axis defined by a spacer bar 26 at one of its ends. To prevent the lid from rotating freely in the absence of user input, the lid may be provided with an anchoring assembly 35 at its free end, such as a pair of magnets 38, which are an example of a non-contact security mechanism. In the illustrated embodiment, the lid is provided with a pair of magnets 38 glued and press fit into the aluminum material of the body and lid. Though under some circumstances it may be sufficient to simply press fit the magnets 38 to the body 12 of the case, this risks having the magnets become dislodged under extremes of temperature (and, thus, expansion and contraction of the body material). As well, in some embodiments the body may be constructed of a material for which press fitting alone may not provide optimal performance, such as when the body is ABS plastic, carbon fiber, etc.

In some embodiments, the magnets will be configured as rare earth magnets, which are strong for their size. As well, some embodiments of the case may be constructed of a magnetically attractive material, such as steel. In these embodiments, the magnets will naturally function to hold the lid securely against the case body 12 when the lid is in its closed position. Other embodiments of the case may be constructed of a non-magnetically attractive material, such as carbon fiber. In these embodiments, there may be complementary magnets 38 fastened to the body of the case in positions where the attractive forces between the lid and body magnets will function to secure the lid when it is placed in a closed position. Of course, the magnets may be attached to the body when the hanger or lid is magnetically attractive.

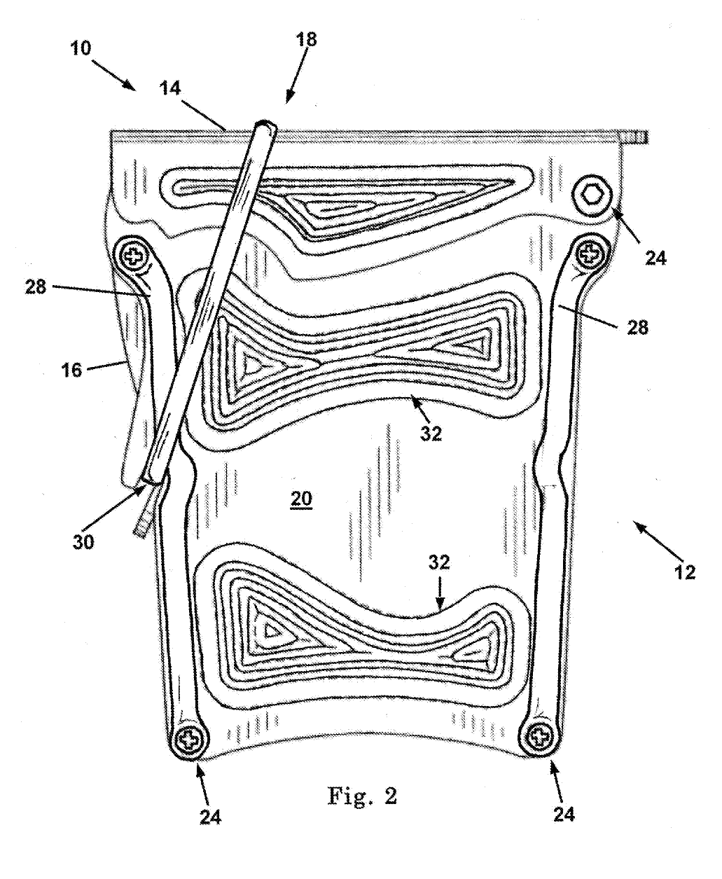

In some situations, it may be that the attractive force of the one or more magnets, tending to secure the lid in its closed position, is not sufficient to resist an external force applied to the camera case and tending to open the lid (e.g. if the camera case is dropped and undergoes a sudden impact force). To supplement the magnetic closure system and provide security in these situations, the securement mechanism, or shock cord, may be stretched between the anchor hole and one or both of the notches 30, as noted above (and as shown in FIG. 2).

As noted earlier, the case 10 may include a hanger 16 useful for attaching the case to a fixed or movable attachment mechanism. For this purpose, the hanger may be hinged at a point on the case, for example at one of the spacer bars 26. As well, the hanger may define a loop 40 through which an attachment mechanism may be placed. As one example, a carabiner may be used to couple the camera case 10, via hanger loop 40, to a harness worn by a person, or to another piece of outdoor equipment, or to a storage hook.

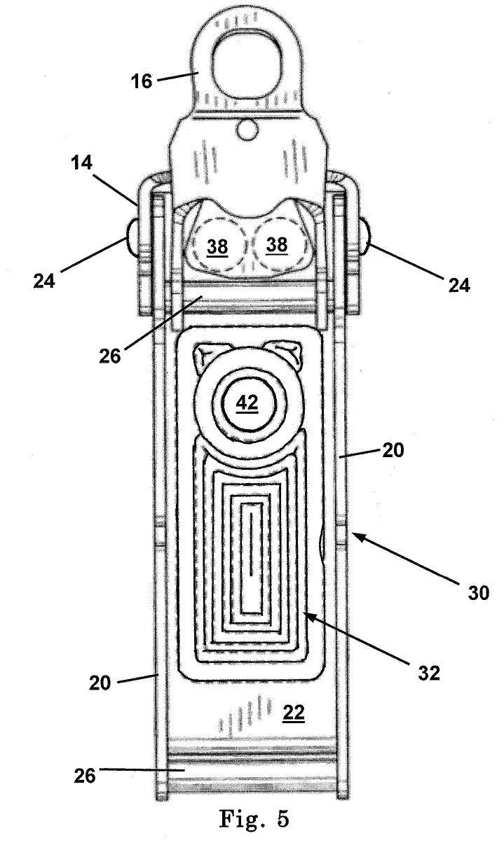

As shown in FIGS. 1 and 5, the hanger may be placed in either a raised or lowered position. As with the lid, the hanger 40 may include one or more magnets 42 that may function to hold the hanger in a lowered position. Also as with the lid, the hanger magnet 42 may function on its own to hold the hanger in position (if the case is constructed of a magnetically attractive material), or may cooperate with one or more magnets coupled to the case body 12 at a complementary position. When the hanger 16 is placed in its lowered position, it may reside within the profile of the body of the case (as seen in FIG. 2).

One aspect of use of the case arises from the configuration of the hanger and the lid. As can be seen from the Figures, the hanger 16 is mounted near the top of the case at a location close to the free end of the lid. The lid is mounted rotatably, or hinged, at the side of the case away from the position of the hanger. Thus, when the case is suspended from its hanger (such as, for example, when the case is attached via carabiner to a climbing harness), the lid will tend to stay in an open position once the attractive force between the lid magnets 38 and the case body 12 is broken by manually opening the lid. This will make placing a camera into, or removing a camera from, the central portion of the case a relatively straightforward task.

Having described the components of the illustrated embodiment of an electronics or camera case, there follows a method of its use.

Typically, a user of the case will retain it in a “resting” state, where the case is empty, the hanger is lowered against the side of the body, and the lid is closed. In this state, the securement mechanism, or shock cord, 18, is typically stored in a taut configuration along the top of the lid, with a knot at one of its ends pulled against the inside of the anchor hole, and a knot at its other end pulled against the underside of the securement notch 36.

To open the lid, the user may simply grasp the lid at its free end, near the magnets 38, and urge the free end of the lid upward. This will overcome the attractive force between the magnets 38 and the body (or the one or more complementary magnets) and allow the lid to swing open. This operation will be the same regardless of whether the case is free or suspended from its hanger 16. Although, if the case is suspended from its hanger 16, the lid 14 of the illustrated embodiment may have a greater tendency to remain in its open position. Alternatively, the user may open the lid by first releasing an end of the shock cord (as described below), and then pulling on the shock cord (and thus, its attachment to anchor hole 34) to open the lid.

Once the lid is open, the user may place a camera or other appropriately-sized electronic device within the central opening (defined by the central shell 22) of the case. Of course, although referred to as a camera or electronic device, a user may place with the central shell any item for which the user desires robust protection. While placing the device within the central shell, the user may allow a wrist cord of the device (if present) to hang outside the shell, thus allowing the cord to be grasped before the user later withdraws the device from the case (thus ensuring an extra measure of safety against dropping the device).

Once a chosen device is placed within the central portion of the case, the user may close the lid over the device, rotating the lid around its hinged attachment at spacer bar 26. Closing the lid reinitiates the attractive force between magnets 38 and the body 12 of the case, or any complementary magnets that may be present, which tends to hold the lid in its closed position. For an extra measure of security, the user may secure the lid in its closed position by using the securement mechanism (which will be described with reference to a shock cord 18).

To secure the lid with shock cord 18, the user may first grab the knot at the end of the shock cord held in securement notch 36. By pulling on the knot, and thus lengthening the shock cord, the user may release one end of the shock cord from its securement notch attachment point (while the other end of the shock cord remains attached to anchor hole 34). The user may then move the free end of the shock cord and place the knot of the free end in one of the notches 30. Typically, the user will run the shock cord down one side of the case and place the knot within the notch 30 on that side of the case, as shown in FIG. 2.

Once the knot is placed in the notch 30 of the side, the user may then release the shock cord. The resilient nature of the shock cord will cause it to tend to retract, pulling the knot against the notch and providing a second securing attachment that prevents the lid from swinging freely open. Alternatively, to provide an even stronger securing force to the lid, the user may stretch the shock cord further, extending it across the gap between the side walls 20 so that the shock cord passes through a first notch and the knot is held against a second notch since, as shown in FIG. 4, the pair of notches may be relatively closely arranged on either of side of the central shell. This arrangement can be made with the hanger 16 in either its up or down position.

To reopen the camera case, the user simply pulls again on the shock cord, releasing the knot in the end of the shock cord from the notch in which it was held, and lifts the free end of the lid from the position in which it is held by its magnets. Before opening the camera case, the user has the option of placing the wrist strap of the device on his or her wrist, since (as noted above) the wrist strap can extend over the upper edge of the side wall 20 of the case and be left hanging outside the case when the lid of the case is closed.

Notably, each of the actions described above can be performed by the user using just one of his or her hands. It is not necessary, for any step, that the user manipulates the case or the device with both hands. This has many benefits for the user, including increasing the safety of the user when he or she desires access to the case but would like to increase his or her own safety factor (for example, by maintaining a handhold while climbing).

Another benefit of the design of the illustrated embodiment of a camera case is the ease with which it can be constructed. Components useful for constructing the camera case can be cut, stamped, or machined from sheet steel, aluminum, or any other appropriate material. As well, the components could be made from more exotic or cheaper materials than can be formed, molded, or injection molded to a useful shape, such as carbon fiber, ABS plastic, or other thermoformable material.

One method of manufacturing the case components could include machining 6061 T6 or 5051 aluminum alloy with a three-axis computer-numeric-controlled (CNC) vertical milling machine. If the components are machined from flat stock, the components may then be folded, anodized, and/or assembled using fasteners of an appropriate sort (such as stainless steel screws, bolts, spacers, etc.).

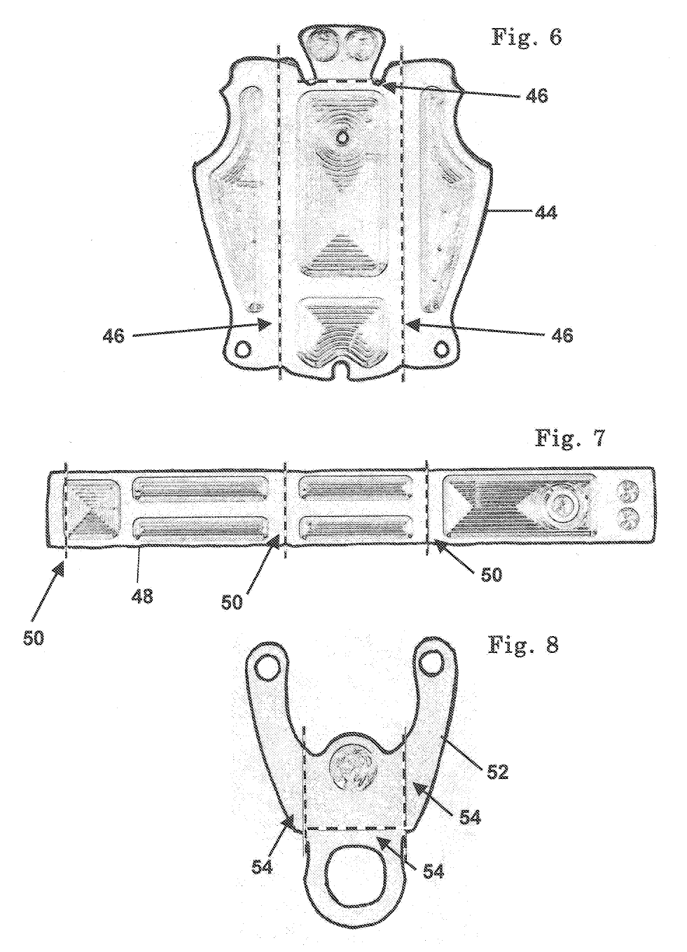

For example, FIGS. 1-5 show that the side walls 20 are constructed as simple sheet elements that can have machined elements 32 configured to make the case easier to grasp, reduce its weight, and add to the aesthetics of the case. The same Figures show that the lid 14, hanger 16, and central shell 22 are not simple sheet elements in this particular embodiment. However, FIGS. 6-8 show that the three components which are not plain sheet elements can be cut or machined from sheet material and then folded or otherwise manipulated into their final form.

FIG. 6 shows a lid form 44, which may be cut from sheet material into a shape roughly like that of a butterfly. Fold lines 46 overlaid on lid form 44 show where the sheet material, once cut, may be folded to approximately 90-degree angles to take the final shape of a lid. FIG. 7 shows a shell form 48 for central shell 22, which may be cut in an extended rectangular shape. Also in FIG. 7, fold lines 50 show where the shell form may be folded to yield the final shape of the central shell. Finally, FIG. 8 shows a hanger form 52 that may be cut from a sheet material and then folded along fold lines 54 to yield the final shape of hanger 16. Of course, though shown as being constructed from formed and folded sheet structural material, the principles of operation of the disclosed case (described above) will apply to cases constructed by many other methods and of other materials.

Other aspects of the construction also bear mentioning. First, the case is constructed essentially like a “sandwich,” with the central shell 22 being held between side walls 20. To hold the side walls in place, and secure the central shell, the case utilizes a number of screws, bolts, and spacer bars. Because these replaceable elements are used to construct the case (as opposed to welding or otherwise permanently fixing the components of the case), a user of the case may rather easily perform maintenance to extend the life of the case or to replace damaged parts. As one example, if any interior foam of the case became damaged or excessively dirty, the user could disassemble the case, remove or clean the foam, and simply put the case back into its final form. However, in some embodiments, the components may be permanently fixed by welding, gluing, or other means.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Inventions embodied in various combinations and subcombinations of features, functions, elements, and/or properties may be claimed through presentation of claims in a related application.

I claim:

1. A protective case, comprising:
a body substantially enclosing an interior space;
a lid coupled to the body;
a first non-contact lid securing mechanism;
a second lid securing mechanism; and
one or more shaped depressions in the body of the case.

2. The case of claim 1, wherein the first lid securing mechanism comprises one or more magnets coupled to the lid.

3. The case of claim 2, wherein the second lid securing mechanism comprises a length of elastic material.

4. The case of claim 1, wherein the second lid securing mechanism comprises a length of elastic material.

5. The case of claim 4, wherein at least one of the lid and the body is comprised substantially of a metallic material.

6. The case of claim 5, wherein the body and the lid are comprised substantially of aluminum.

7. The case of claim 4, wherein at least one of the lid and the body is comprised substantially of a non-metallic material.

8. The case of claim 7, wherein the body and the lid are comprised substantially of carbon fiber.

9. The case of claim 4, wherein the length of elastic material includes a first end and a second end, wherein the length of elastic material is coupled to the lid at the first end.

10. The case of claim 9, further comprising a notch on the body, wherein the length of elastic material is configured to be coupled to the notch at the second end when the lid is in a secured position.

11. The case of claim 1, wherein the lid includes a securement notch, wherein the second lid securing mechanism comprises a length of elastic material, wherein the length of elastic material includes a first end and a second end, and wherein the length of elastic material is coupled to the lid at each of its first and second ends.

12. A protective case, comprising:
a substantially parallelepiped body enclosing a central space, wherein the central space is accessible through an opening of the body;
a lid rotatably coupled to the body at a first position and configured to rotate between an open position and a closed position, wherein the lid covers the opening to the central space when the lid is in the closed position;
at least one magnetic fastener for securing the lid; and
a hanger rotatably coupled to the body at a second position, wherein the hanger is configured to rotate from an upper raised position and a lowered stowed position.

13. The case of claim 12, further comprising a magnetic fastener for securing the hanger, and still further comprising a pair of magnets coupled to the body, positioned such that a first magnet of the pair attractively interacts with the magnetic fastener of the lid when the lid is closed, and a second magnet of the pair attractively interacts with the magnetic fastener of the hanger when the hanger is in its stowed position.

14. The case of claim 12, further comprising a resilient cord securement mechanism, wherein the cord is configured to be coupled at a first one of its ends to the lid, and at a second one of its ends to the body of the case.

15. The case of claim 14, wherein the body and the lid are comprised substantially of aluminum.

16. The case of claim 15, further comprising at least one shaped depression in at least one of the body and the lid of the case.

17. A method of manufacturing a protective case, comprising:
forming a plurality of components of the case from a sheet structural material;
folding at least one of the plurality of components from its sheet form to a final form; and
fixing the components in a final configuration.

18. The method of claim 17, wherein the step of forming includes cutting the plurality of components from a sheet of metallic material.

19. The method of claim 18, wherein the metallic material is aluminum.

20. The method of claim 17, wherein the step of fixing includes the steps of sandwiching a shell component between a pair of substantially planar walls, placing at least one spacer between the walls, and bolting the walls to the at least one spacer.
